(19) United States
(12) Patent Application Publication
(10) Pub. No.: US 2024/0356485 A1
(43) Pub. Date: Oct. 24, 2024

(54) ROTATING SUPPORT FOR THE ORIENTATION OF A SHAFT SUPPORTING A SOLAR PANEL

(71) Applicant: A. Raymond et Cie, Grenoble (FR)

(72) Inventors: Emmanuel Turlot, Grenoble (FR); Christian Friedrich, Los Osos, CA (US)

(21) Appl. No.: 18/701,732

(22) PCT Filed: Sep. 13, 2022
(86) PCT No.: PCT/EP2022/075342

§ 371 Date: Apr. 16, 2024

Related U.S. Application Data
(60) Provisional application No. 63/271,035, filed on Oct. 22, 2021.

(30) Foreign Application Priority Data
Oct. 26, 2021 (FR) FR2111338

(51) Int. Cl. H02S 20/32

(52) U.S. Cl. CPC H02S 20/32

(57) ABSTRACT

A rotatable support for the orientation of a shaft supporting a solar panel includes a clamp having an internal surface that is rotationally symmetrical about a main axis, and a rotatable element mounted in the clamp, and provided with a peripheral surface that is rotationally symmetrical about the main axis. The support further includes controllable, advantageously mechanical, friction means, configured to impose a friction associated with a first or a second static friction torque on the peripheral surface and/or the internal surface, and opposing the rotation of the rotatable element, the first static friction torque being less than the second static friction torque.

### CROSS REFERENCE TO RELATED APPLICATIONS

This application is a national phase entry under 35 U.S.C. § 371 of International Patent Application PCT/EP2022/075342, filed Sep. 13, 2022, designating the United States of America and published as International Patent Publication WO 2023/066568 A1 on Apr. 27, 2023, which claims the benefit under Article 8 of the Patent Cooperation Treaty to U.S. Patent Application Ser. No. 63/271,035, filed Oct. 22, 2021 and to French Patent Application Serial No. FR2111338, filed Oct. 26, 2021.

### TECHNICAL FIELD

The present disclosure relates to the field of solar energy, and, in particular, to solar panel installations. In this respect, the present disclosure relates to a means for limiting, or even preventing, vortex effects on solar panels. In particular, the present disclosure proposes a rotatable support.

### BACKGROUND

Nowadays, solar panels are advantageously mounted so as to be rotatable in one or two rotation directions in order to follow, at least partially, the path of the sun and improve the conversion efficiency of the panels.

In this respect, a solar installation known to a person skilled in the art, and described in document [1] cited at the end of the description, may comprise a plurality of solar panels.

In particular, and as shown in FIG. 1 (corresponding to [FIG. 3] of document [1]), these solar panels 100 are rigidly interconnected via a torque rail 154 that extends in a main direction A.

In this example, the torque rail 154 is mounted on one or more poles 152, which are fixed to the ground. In particular, this mounting uses rotatable supports 148 that are attached to the ends of each pole 152 and are configured to allow the rotation of the torque rail 154, and consequently the solar panels 100, about the main axis A.

As shown in FIG. 2 (corresponding to [FIG. 4] of document [1] cited at the end of the description), the rotatable support 148 comprises, in particular, a rotatable element 178 held within a clamp 164. The torque rail 154 also passes right through the rotatable element 178 in the direction defined by the main axis A (FIG. 1).

Such an arrangement allows the assembly formed by the rotatable element 178 and the torque rail 154 to pivot about the main axis A, thereby allowing the solar panels that are mechanically connected to the rail to follow the path of the sun.

This rotational movement is imposed, in particular, by a motor acting directly on the torque rail 154.

Such an installation may comprise a safety function that consists in placing the solar panels in a horizontal position as soon as the wind exceeds a critical speed. This function makes it possible, in particular, to reduce the wind load on the panels, and consequently to limit the risk of damage to the panels.

This safety function is, however, only effective when the wind remains parallel to the ground surface. Indeed, as soon as the wind forms vortices, the solar panels supported by the torque rail may undergo stresses, and, in particular, torsional stresses of high amplitudes, outside of their plane. More particularly, and for certain wind speeds, these stresses are likely to cause resonance of the assembly formed by the rail and the solar panels, and may potentially cause detachment, or even tearing off, of some of these panels, due to the strong accelerations imposed by this torsional movement.

In order to overcome this problem, the use of mechanical and/or hydraulic dampers configured to limit the effects of vortices has been proposed (in particular, in documents [2] and [3] cited at the end of the description). Alternatively, document [4] cited at the end of the description proposes using a damping means based on an eddy current effect.

Finally, document US2020/0208881 A1 discloses a rotatable support for solar panels.

The means described above are nevertheless complicated to implement and are often associated with a cost that is not compatible with the field of solar energy.

An aim of the present disclosure is therefore to propose a device that makes it possible to limit, or even prevent, the effects of vortices on solar panel installations.

More particularly, an aim of the present disclosure is to propose a device that is simpler to use and, above all, compatible with existing solar installations.

### BRIEF SUMMARY

The present disclosure relates to a rotatable support for the orientation of a shaft supporting a solar panel:
a clamp comprising an internal surface that is rotationally symmetrical about a main axis;
a rotatable element mounted within the clamp and having a peripheral surface that is rotationally symmetrical about the main axis; and
controllable, advantageously mechanical friction means that are configured to impose a friction that is associated with a first or a second static friction torque on the peripheral surface and/or the internal surface, and that oppose the rotation of the rotatable element, the first static friction torque being smaller than the second static friction torque.

According to one embodiment, the rotatable element comprises an assembly of two sections, referred to as the first section and second section, respectively, which, when assembled to form the rotatable element, are symmetrical relative to a plane passing through the main axis.

According to one embodiment, the rotatable element comprises two main faces that are connected by the peripheral surface and through which a channel opens for guiding the shaft.

According to one embodiment, the guide channel has a rectangular or square cross-section in a sectional plane perpendicular to the main axis.

According to one embodiment, the internal surface and the peripheral surface are spherical in shape.

According to one embodiment, the friction means comprise a membrane that can be inflated with a gas or a liquid and is interposed between the peripheral surface and the internal surface.

According to one embodiment, the inflatable membrane is secured to the internal surface such that the controllable friction means are configured to impose the first or second static friction torque on the peripheral surface.

According to one embodiment, the inflatable membrane is secured to the peripheral surface such that the controllable friction means are configured to impose the first or second static friction torque on the internal surface.

According to one embodiment, the friction means comprise an actuator that is configured to adjust the clamping of the rotatable element within the clamp to either a first degree of clamping or a second degree of clamping, the first and second degrees of clamping making it possible to impose the first and second static friction torque, respectively, between the peripheral surface and the internal surface.

According to one embodiment, the clamp comprises two sections referred to as an upper section and lower section, respectively, which are assembled on a plane passing through the main axis.

According to one embodiment, the clamp comprises galvanized steel.

According to one embodiment, the rotatable element comprises plastics material.

According to one embodiment, the clamp comprises a longitudinal holding element that projects from the outer surface thereof.

The present disclosure also relates to a solar installation comprising:
a plurality of poles;
a shaft that extends along the main axis and that is rigidly connected to one end of each of the poles of the plurality of poles via rotatable supports according to the present disclosure;
a solar panel rigidly connected to the shaft;
a plurality of motors arranged to impose a torque for rotating the shaft about the main axis.

According to one embodiment, the first static friction torque is adjusted to allow the rotation of the shaft when the motors impose a rotational torque on the shaft.

### BRIEF DESCRIPTION OF THE DRAWINGS

Other features and advantages of the invention will emerge from the following detailed description of the present disclosure with reference to the accompanying figures, in which:

FIG. 1 corresponds to [FIG. 3] of document [1] cited at the end of the description, in particular, FIG. 1 shows at least one solar panel rotatably mounted about a main axis;

FIG. 2 corresponds to [FIG. 4] of document [1] cited at the end of the description, in particular, FIG. 2 shows a rotatable support described in document [1];

FIG. 3 is a schematic representation of a rotatable support according to a first embodiment of the present disclosure, the rotatable element is, in particular, shown in a sectional plane that is perpendicular to the main axis XX′;

FIG. 4 is a representation of the clamp of the rotatable support of FIG. 3, the clamp is shown, in particular, in a sectional plane C that is perpendicular to the main axis XX′;

FIG. 5 is a representation of the rotatable element of the rotatable support of FIG. 3, the rotatable element is shown, in particular, in the sectional plane C;

FIG. 6 is a representation of the rotatable element of FIG. 5, the rotatable element is shown, in particular, in the sectional plane that is perpendicular to the sectional plane C and passes through the main axis XX′;

FIG. 7 is a schematic representation of a rotatable support according to a second embodiment of the present disclosure, the rotatable element is shown, in particular, in a sectional plane that is perpendicular to the main axis XX′, and the friction means impose the second static friction torque;

FIG. 8 is a schematic representation of a rotatable support of FIG. 7, with the friction means imposing the first static friction torque;

FIG. 9 is an image of an installation capable of using the rotatable support according to the present disclosure.

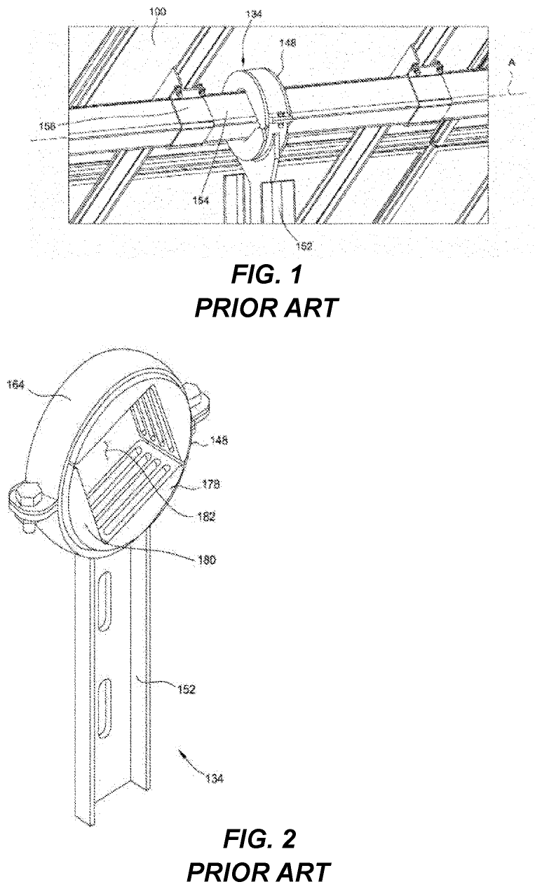

### DETAILED DESCRIPTION

The present disclosure relates to a rotatable support. More particularly, the present disclosure relates to a rotatable support that is intended to hold a shaft supporting a solar panel.

More particularly, the rotatable support comprises:
a clamp comprising an internal surface that is rotationally symmetrical about a main axis;
a rotatable element mounted within the clamp and having a peripheral surface that is rotationally symmetrical about the main axis; and
controllable friction means that are configured to impose a friction that is associated with a first or a second static friction torque on the peripheral surface and/or the internal surface, and that oppose the rotation of the rotatable element, the first static friction torque being smaller than the second static friction torque.

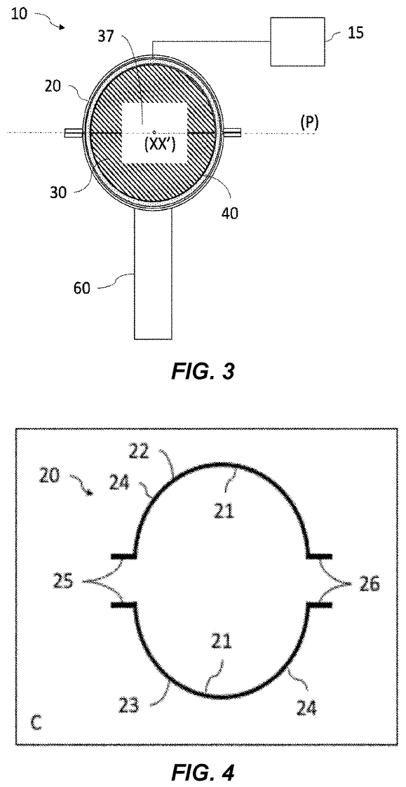

In FIG. 3, a first example of a rotatable support 10 according to the present disclosure can be seen.

The rotatable support 10 comprises, in particular, a clamp 20. The clamp 20 comprises an internal surface 21 (FIG. 4) and is rotationally symmetrical about a main axis XX′.

The clamp 20 can comprise two sections referred to as an upper section 22 and lower section 23, respectively, which are assembled along a plane P passing through the main axis XX′ (FIG. 3).

More particularly, as shown in FIG. 4, each section of the clamp 20 comprises a central portion 24 and two end portions, referred to as a first end portion 25 and second end portion 26, respectively.

The central portion 24 forms a semi-circle along a sectional plane C perpendicular to the main axis XX′. The end portions form tabs parallel to the plane P and terminate the central portion laterally. In other words, the central portion is arranged between the first end portion 25 and the second end portion 26.

The end portions make it possible to keep the upper section 22 and the lower section 23 assembled. In particular, the first end portions of each of the sections bear against each other and are held together by fastening means. In an equivalent manner, the second end portion of each of the sections bear against each other and are held together by fastening means. The fastening means can, for example, comprise screws or bolt/nut systems.

The clamp 20 can comprise galvanized steel.

The clamp 20 can comprise a longitudinal holding element 60 that projects from the outer surface thereof. The holding element 60 is configured, in particular, to attach the rotatable support 10 to a pole.

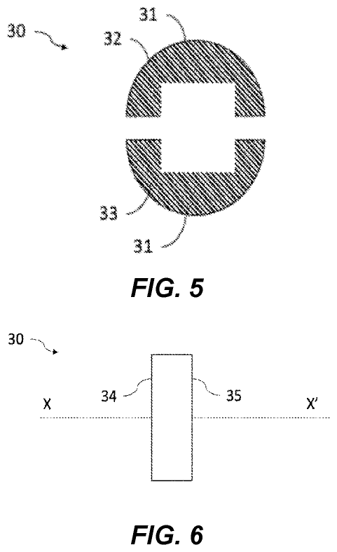

The rotatable support 10 also comprises a rotatable element 30 mounted within the clamp 20. More particularly, the rotatable element 30 is rotatably mounted about the main axis XX′. In this respect, the peripheral surface 31 (FIG. 5) is rotationally symmetrical about the main axis XX′.

Advantageously, the rotatable element 30 can comprise an assembly of two sections referred to as a first section 32 and second section 33, respectively, which, when assembled to form the rotatable element 30, are symmetrical relative to a plane passing through the main axis XX′ (FIG. 5).

Furthermore, the rotatable element 30 comprises two main faces 34, 35 (FIG. 6) connected by the peripheral surface 31, and through which a channel 37 (FIG. 3) opens for guiding the shaft. It is understood that the main faces 34, 35 are parallel to one another.

The guide channel 37 can have a rectangular or square cross-section in a sectional plane that is perpendicular to the main axis XX′.

The rotatable element 30 can comprise a plastic material, for example, a thermoplastic material, and more favorably a polyamide, a polypropylene, or a high-density polyethylene.

More particularly, the rotatable element 30 can be made of materials of different density. By way of example, the rotatable element 30 can comprise a peripheral layer made of a material having a first density, and covering a main portion made of a material having a second density that is greater than the first density.

The rotatable support 10 also comprises controllable friction means that are configured to impose a friction that is associated with a first or a second static friction torque on the peripheral surface 31 and/or the internal surface 21, and that oppose the rotation of the rotatable element 30, the first static friction torque being smaller than the second static friction torque.

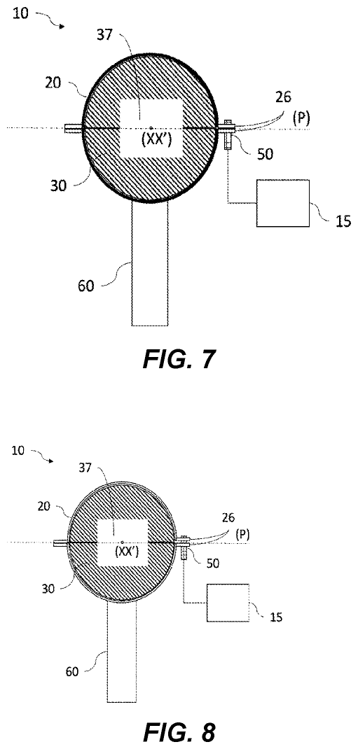

Here “controllable” is understood to mean that there is a controller 15 (FIG. 3 and FIG. 7) that makes it possible to control the friction means in order to impose either of the first or second static friction torque.

A static friction torque is, according to the terms of the present disclosure, a torque that opposes the rotational motor torque, whether it comes from an electric motor or the action of the wind on the panels.

According to this first example, the friction means comprise a membrane 40 (FIG. 3) that can be inflated with a gas or a liquid and that is arranged between the peripheral surface 31 and the internal surface 21. In this respect, the inflatable membrane 40 can have two states referred to as a first state and second state, respectively. In particular, the first state and the second state are suitable for imposing the first static friction torque and the second static friction torque, respectively. In particular, both the first state and the second state are the result of a quantity of gas or liquid injected into the membrane. In particular, this quantity of gas or liquid can be adjusted by way of the controller 15.

According to a first variant of this first example, the inflatable membrane 40 is secured to the internal surface 21 such that the controllable friction means are configured to impose the first or second static friction torque on the peripheral surface 31.

According to a second variant of this first example, the inflatable membrane 40 is secured to the peripheral surface 31 such that the controllable friction means are configured to impose the first or the second static friction torque on the internal surface 21.

According to a third variant of this first example, the inflatable membrane 40 can be positioned between the internal surface 21 and the peripheral surface 31 without, however, being rigidly connected to either of these two surfaces. According to this configuration, a friction is exerted, on the one hand, between the inflatable membrane 40 and the internal surface 21 and, on the other hand, between the inflatable membrane 40 and the peripheral surface 31.

In FIG. 7, a second example of a rotatable support 10 according to the present disclosure can be seen.

This second example differs from the first example in that the friction means comprise an actuator 50 that is configured to adjust the clamping of the rotatable element 30 within the clamp 20 to either a first degree of clamping or a second degree of clamping, the first and second degrees of clamping making it possible to impose the first and second static friction torque, respectively, between the peripheral surface 31 and the internal surface 21.

In particular, and according to the example shown in FIG. 7, the actuator 50 can be configured to adjust the degree of clamping of the clamp, which is aimed at moving the second end portions 26 either toward or away from one another.

In this respect, FIGS. 7 and 8 show the rotatable support 10 with different spacings between the second end portions 26. In particular, in FIG. 7 the second end portions 26 have a smaller spacing than that shown in FIG. 8. Managing the spacing of the second end portions 26 makes it possible to impose either the first or the second static friction torque between the peripheral surface 31 and the internal surface 21.

A rotatable support such as this is advantageously used to hold and orient a shaft supporting at least one solar panel.

Thus, the present disclosure also relates to a solar installation.

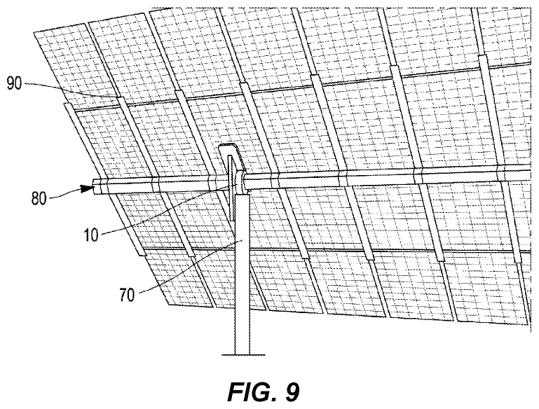

The solar installation, in particular, comprises at least one pole 70 (FIG. 9) having a free end. The free ends of each of the poles 70 are, in particular, aligned in a direction parallel to the main axis XX′.

The installation also comprises a plurality of rotatable supports 10. More particularly, the rotatable support 10 is attached to a free end of a pole 70 so that the guide channel of the rotatable supports is aligned along the main axis XX′.

The installation further comprises a shaft 80 that extends along the main axis XX′. In other words, the shaft passes through all of the guide channels.

At least one solar panel 90 is attached to the shaft 80.

Finally, the installation comprises a plurality of motors arranged to impose a torque for rotating the shaft about the main axis XX′.

Advantageously, the internal surface 21 and the peripheral surface 31 are spherical in shape. This aspect makes it possible to accommodate slight misalignments between the various elements forming the solar installation.

In operation, when the motors are activated, they enable a rotational movement to be imposed on the shaft in order to orient the solar panel or panels to face the sun. During this rotation, the friction means impose a friction equal to the first static friction torque so as to limit the force on the motors. For example, the first friction torque may be less than 1% of the motor torque.

As soon as the solar panel has reached the desired orientation, the motor or motors are deactivated, and the friction means impose a friction equal to the second static friction torque so as to limit the force on the motors. For example, the second friction torque may be greater than 10% of the motor torque.

This second state makes it possible to damp the vortex effects by limiting the rotational movements of the panels (and/or oscillation about the main axis XX′).

Of course, the present disclosure is not limited to the described embodiments and variant embodiments may be envisaged without departing from the scope of the invention as defined by the claims.

### REFERENCES

[1] US 2020/0076357 A1;
[2] US 2018/0013380 A1;
[3] US 2020/0244216 A1;
[4] EP3608605B1.

1. A rotatable support for the orientation of a shaft supporting a solar panel, the rotatable support comprising:
a clamp having an internal surface that is rotationally symmetrical about a main axis;
a rotatable element mounted within the clamp and having a peripheral surface that is rotationally symmetrical about the main axis; and
controllable friction means configured to impose a friction associated with a first static friction torque or a second static friction torque on the peripheral surface and/or the internal surface, the first static friction torque and the second static friction torque opposing rotation of the rotatable element, the first static friction torque being smaller than the second static friction torque.

2. The rotatable support of claim 1, wherein the rotatable element comprises an assembly of a first section and a second section, which, when assembled to form the rotatable element, are symmetrical relative to a plane passing through the main axis.

3. The rotatable support of claim 1, wherein the rotatable element comprises two main faces connected by the peripheral surface, a guide channel extending through the rotatable element for guiding the shaft.

4. The rotatable support of claim 3, wherein the guide channel has a rectangular or square cross-section in a sectional plane perpendicular to the main axis.

5. The rotatable support of claim 1, wherein the internal surface and the peripheral surface are cylindrical in shape.

6. The rotatable support of claim 1, wherein the friction means comprise a membrane capable of being inflated with a gas or a liquid and interposed between the peripheral surface and the internal surface.

7. The rotatable support of claim 6, wherein the inflatable membrane is secured to the internal surface such that the controllable friction means are configured to impose the first friction torque or the second static friction torque on the peripheral surface.

8. The rotatable support of claim 6, wherein the inflatable membrane is secured to the peripheral surface such that the controllable friction means are configured to impose the first friction torque or the second static friction torque on the internal surface.

9. The rotatable support of claim 1, wherein the friction means comprise an actuator configured to adjust a clamping of the rotatable element within the clamp to either a first degree of clamping or a second degree of clamping, the first degree of clamping and the second degree of clamping imposing the first static friction torque and the second static friction torque, respectively, between the peripheral surface and the internal surface.

10. The rotatable support of claim 9, wherein the clamp comprises an upper section and a lower section, which are assembled on a plane passing through the main axis.

11. The rotatable support of claim 1, wherein the clamp comprises galvanized steel.

12. The rotatable support of claim 1, wherein the rotatable element comprises a plastic material.

13. The rotatable support of claim 1, wherein the clamp comprises a longitudinal holding element projecting from an outer surface thereof.

14. A solar installation, comprising:
a plurality of poles;
a shaft extending along a main axis, the shaft being rigidly connected to one end of each of the poles of the plurality of poles via rotatable supports, each of the rotatable supports including:
a clamp having an internal surface that is rotationally symmetrical about the main axis;
a rotatable element mounted within the clamp and having a peripheral surface that is rotationally symmetrical about the main axis; and
controllable friction means configured to impose a friction associated with a first static friction torque or a second static friction torque on the peripheral surface and/or the internal surface, the first static friction torque and the second static friction torque opposing rotation of the rotatable element, the first static friction torque being smaller than the second static friction torque;
at least one solar panel rigidly connected to the shaft; and
at least one motor configured to impose a torque for rotating the shaft about the main axis.

15. The solar installation of claim 14, wherein the first static friction torque is adjusted to allow the rotation of the shaft when the at least one motor imposes a rotational torque on the shaft.

16. The solar installation of claim 1, wherein the controllable friction means comprises mechanical friction means.

17. A rotatable support for the orientation of a shaft supporting a solar panel, the rotatable support comprising:
a clamp having an internal surface;
a rotatable element mounted within the clamp and having a peripheral surface, the rotatable element configured to rotate within the clamp about a main axis; and
a controllable mechanism located and configured to impose different levels of friction on the peripheral surface and/or the internal surface, the different levels of friction providing at least a first static friction torque and a second static friction torque opposing rotation of the rotatable element, the first static friction torque being smaller than the second static friction torque.

18. The rotatable support of claim 17, wherein the controllable mechanism comprises an inflatable membrane interposed between the peripheral surface and the internal surface.

19. The rotatable support of claim 18, wherein the inflatable membrane is secured to the internal surface such that the controllable friction means are configured to impose the first friction torque or the second static friction torque on the peripheral surface.

20. The rotatable support of claim 17, wherein the controllable mechanism comprises an actuator configured to adjust a clamping of the rotatable element within the clamp to either a first degree of clamping or a second degree of clamping, the first degree of clamping and the second degree of clamping imposing the first static friction torque and the second static friction torque, respectively, between the peripheral surface and the internal surface.
